(19) United States
(12) Patent Application Publication
(10) Pub. No.: US 2023/0323637 A1
(43) Pub. Date: Oct. 12, 2023

(54) OBSTACLE REPORTING SYSTEM FOR WORK MACHINE, AND OBSTACLE REPORTING METHOD FOR WORK MACHINE

(71) Applicant: Komatsu Ltd., Tokyo (JP)

(72) Inventors: Taro EGUCHI, Tokyo (JP); Koichi NAKAZAWA, Tokyo (JP); Yoshiyuki SHITAYA, Tokyo (JP); Takeshi KURIHARA, Tokyo (JP)

(21) Appl. No.: 18/022,283

(22) PCT Filed: Jul. 12, 2021
(86) PCT No.: PCT/JP2021/026138

§ 371 Date: Feb. 21, 2023

(30) Foreign Application Priority Data
Aug. 21, 2020 (JP) 2020-140271

(51) Int. Cl. E02F 9/26; E02F 9/24; G06F 3/0488

(52) U.S. Cl. CPC E02F 9/261; E02F 9/24; G06F 3/0488; G06F 2203/04808

(57) ABSTRACT

An obstacle determination unit determines whether an obstacle exists in a periphery of the work machine. A reporting unit performs reporting showing the obstacle when determination is made that the obstacle exists. An instruction input unit receives an operation instruction for the reporting. An output unit changes a display mode of the obstacle based on the operation instruction.

### TECHNICAL FIELD

The present invention relates to an obstacle reporting system for a work machine and an obstacle reporting method for a work machine.

Priority is claimed on Japanese Patent Application No. 2020-140271, filed August 21, 2020, the content of which is incorporated herein by reference.

### BACKGROUND ART

Patent Document 1 discloses a technique related to a peripheral monitoring system that detects a person in the vicinity of a work machine. According to the technique described in Patent Document 1, the peripheral monitoring system detects an obstacle of the periphery.

### CITATION LIST

### Patent Document

Patent Document 1

Japanese Unexamined Patent Application, First Publication No. 2016-035791

### SUMMARY OF INVENTION

### Technical Problem

When a peripheral monitoring system detects an obstacle, the peripheral monitoring system reports that the obstacle exists from a display, a speaker, or the like. An operator of a work machine receives the reporting by the peripheral monitoring system, confirms that the obstacle exists, and confirms that safety is ensured.

By the way, although the obstacle is detected by the peripheral monitoring system, the operator may not be able to recognize the details of the detected obstacle depending on the content of the reporting.

An object of the present invention is to provide an obstacle reporting system for a work machine and an obstacle reporting method for a work machine that can easily acquire information related to a detected obstacle.

### Solution to Problem

According to a first aspect, an obstacle reporting system for a work machine includes an obstacle determination unit configured to determine whether an obstacle exists in a periphery of a work machine, a reporting unit configured to perform reporting showing the obstacle when determination is made that the obstacle exists, an instruction input unit configured to receive an operation instruction for the reporting, and an output unit that changes a display mode of the obstacle based on the operation instruction.

### Advantageous Effects of Invention

According to the above aspect, the operator of the work machine can easily acquire information related to the detected obstacle.

### BRIEF DESCRIPTION OF DRAWINGS

FIG. 1 is a schematic diagram showing a configuration of a work machine according to a first embodiment.

FIG. 2 is a diagram showing imaging ranges of a plurality of cameras 121 provided in the work machine according to the first embodiment.

FIG. 3 is a diagram showing an internal configuration of a cab according to the first embodiment.

FIG. 4 is a schematic block diagram showing a configuration of a control device according to the first embodiment.

FIG. 5 is a diagram showing an example of a display screen according to the first embodiment.

FIG. 6 is a flowchart showing an operation of the control device according to the first embodiment.

FIG. 7 is a diagram showing an operation example of the control device according to the first embodiment.

FIG. 8 is a diagram showing an operation example of a control device according to a modification example of the first embodiment.

FIG. 9 is a flowchart showing an operation of a control device according to a second embodiment.

FIG. 10 is a diagram showing an operation example of the control device according to the second embodiment.

FIG. 11 is a diagram showing an operation example of a control device according to a first modification example of the second embodiment.

FIG. 12 is a diagram showing an operation example of a control device according to a second modification example of the second embodiment.

FIG. 13 is a diagram showing an operation example of a control device according to a third modification example of the second embodiment.

FIG. 14 is a diagram showing an operation example of a control device according to a third embodiment.

### DESCRIPTION OF EMBODIMENTS

### First Embodiment

Hereinafter, an embodiment of the present invention is described with reference to the drawings.

### Configuration of Work Machine 100

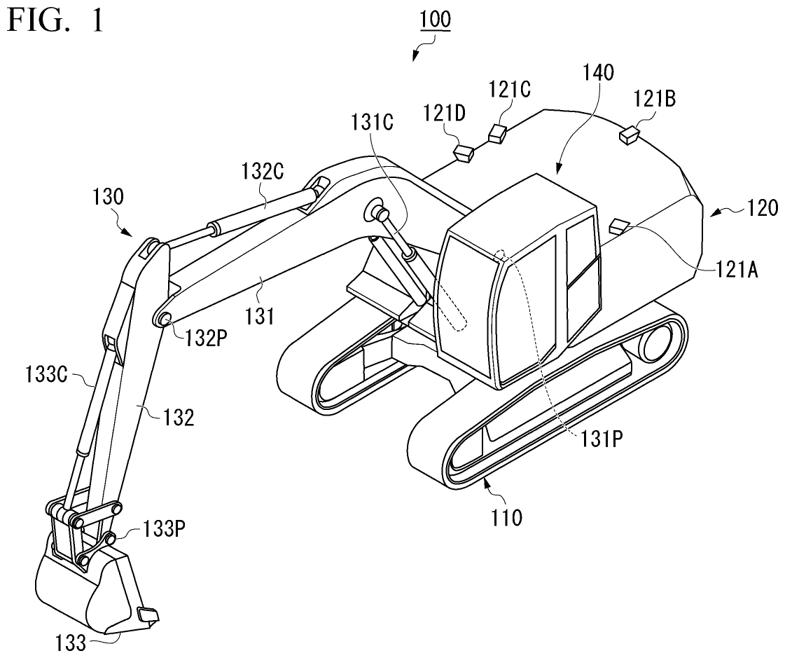

FIG. 1 is a schematic diagram showing a configuration of a work machine 100 according to a first embodiment.

The work machine 100 operates at a construction site and constructs a construction target such as earth. The work machine 100 according to the first embodiment is, for example, a hydraulic excavator. The work machine 100 includes an undercarriage 110, a swing body 120, work equipment 130, and a cab 140.

The undercarriage 110 supports the work machine 100 in a travelable manner. The undercarriage 110 is, for example, a pair of right and left endless tracks.

The swing body 120 is supported by the undercarriage 110 to be swingable around a swing center.

The work equipment 130 is driven by hydraulic pressure. The work equipment 130 is supported by a front portion of the swing body 120 to be drivable in an up to down direction. The cab 140 is a space in which an operator gets in and operates the work machine 100. The cab 140 is provided on a left front portion of the swing body 120.

Here, a portion of the swing body 120 to which the work equipment 130 is attached is referred to as a front portion. In addition, in the swing body 120, a portion on an opposite side, a portion on a left side, and a portion on a right side with respect to the front portion are referred to as a rear portion, a left portion, and a right portion.

### Configuration of Swing Body 120

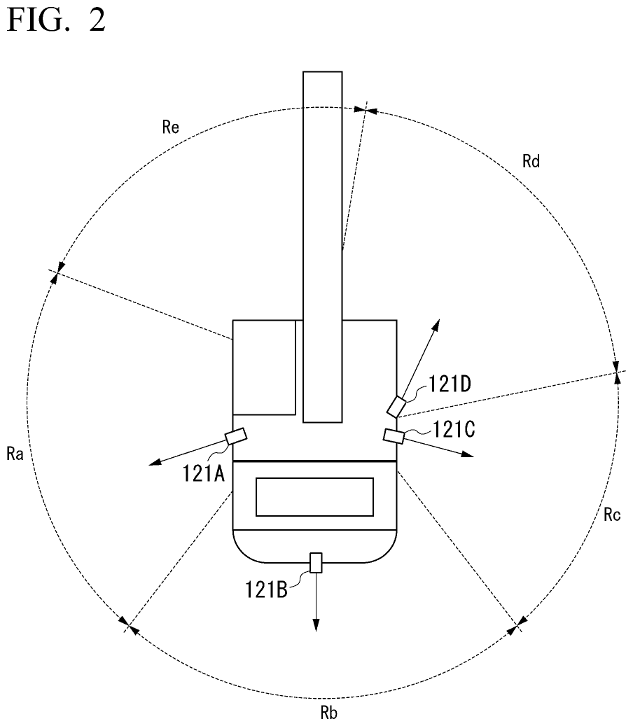

The swing body 120 is provided with a plurality of cameras 121 that capture images of the periphery of the work machine 100. FIG. 2 is a diagram showing imaging ranges of the plurality of cameras 121 provided in the work machine 100 according to the first embodiment.

Specifically, the swing body 120 is provided with a left rear camera 121A that captures an image of a left rear region Ra of the periphery of the swing body 120, a rear camera 121B that captures an image of a rear region Rb of the periphery of the swing body 120, a right rear camera 121C that captures an image of a right rear region Rc of the periphery of the swing body 120, and a right front camera 121D that captures an image of a right front region Rd of the periphery of the swing body 120. Incidentally, the imaging ranges of the plurality of cameras 121 may partially overlap each other.

The imaging ranges of the plurality of cameras 121 cover a range of an entire periphery of the work machine 100 excluding a left front region Re that can be visually recognized from the cab 140. Incidentally, the camera 121 according to the first embodiment captures images of regions on left rear, rear, right rear, and right front sides of the swing body 120, but are not limited thereto in another embodiment. For example, the number of the cameras 121 and the imaging ranges according to another embodiment may differ from the example shown in FIGS. 1 and 2.

Incidentally, as shown by a rear range Ra in FIG. 2, the left rear camera 121A captures an image of a range of a left side region and a left rear region of the swing body 120 but may capture an image of one region thereof. Similarly, as shown by the right rear range Rc in FIG. 2, the right rear camera 121C captures an image of a range of a right side region and a right rear region of the swing body 120, but may capture an image of one region thereof. Similarly, as shown by the right front range Rd in FIG. 2, the right front camera 121D captures an image of a range of a right front region and the right side region of the swing body 120, but may capture an image of one region thereof. In addition, in another embodiment, the plurality of cameras 121 may be used such that the entire periphery of the work machine 100 is set as the imaging range. For example, the left front camera that captures the image of the left front range Re may be provided, and the entire periphery of the work machine 100 may be set as the imaging range.

### Configuration of Work Equipment 130

The work equipment 130 includes a boom 131, an arm 132, a bucket 133, a boom cylinder 131C, an arm cylinder 132C, and a bucket cylinder 133C.

A base end portion of the boom 131 is attached to the swing body 120 via a boom pin 131P.

The arm 132 connects the boom 131 and the bucket 133. A base end portion of the arm 132 is attached to a tip end portion of the boom 131 via an arm pin 132P.

The bucket 133 includes blades that excavate earth or the like, and an accommodating portion that accommodates the excavated earth. A base end portion of the bucket 133 is attached to a tip end portion of the arm 132 via a bucket pin 133P.

The boom cylinder 131C is a hydraulic cylinder to operate the boom 131. A base end portion of the boom cylinder 131C is attached to the swing body 120. A tip end portion of the boom cylinder 131C is attached to the boom 131.

The arm cylinder 132C is a hydraulic cylinder to drive the arm 132. A base end portion of the arm cylinder 132C is attached to the boom 131. A tip end portion of the arm cylinder 132C is attached to the arm 132.

The bucket cylinder 133C is a hydraulic cylinder to drive the bucket 133. A base end portion of the bucket cylinder 133C is attached to the arm 132. A tip end portion of the bucket cylinder 133C is attached to a link member connected to the bucket 133.

### Configuration of Cab 140

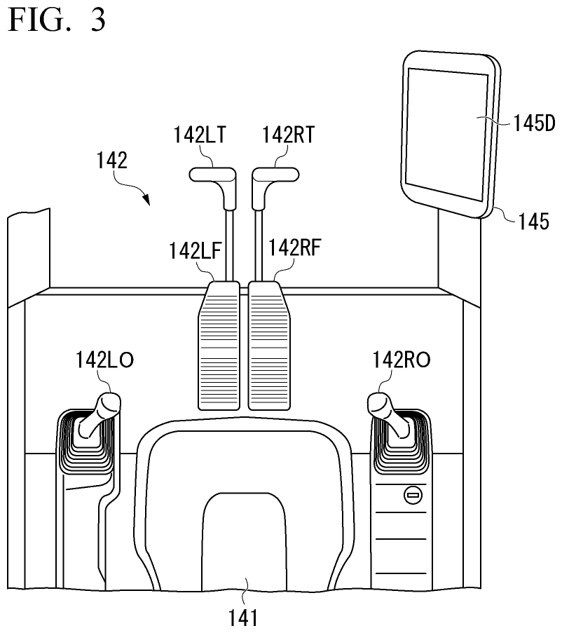

FIG. 3 is a diagram showing an internal configuration of the cab 140 according to the first embodiment.

A driver seat 141, an operation device 142, and a control device 145 are provided in the cab 140.

The operation device 142 is a device to drive the undercarriage 110, the swing body 120, and the work equipment 130 by a manual operation of the operator. The operation device 142 includes a left operation lever 142LO, a right operation lever 142RO, a left foot pedal 142LF, a right foot pedal 142RF, a left traveling lever 142LT, and a right traveling lever 142RT.

The left operation lever 142LO is provided on a left side of the driver seat 141. The right operation lever 142RO is provided on a right side of the driver seat 141.

The left operation lever 142LO is an operation mechanism to cause the swing body 120 to perform a swing operation and to cause the arm 132 to perform an excavating or dumping operation. Specifically, when the operator of the work machine 100 tilts the left operation lever 142LO forward, the arm 132 performs a dumping operation. In addition, when the operator of the work machine 100 tilts the left operation lever 142LO backward, the arm 132 performs an excavating operation. In addition, when the operator of the work machine 100 tilts the left operation lever 142LO in a right direction, the swing body 120 swings rightward. In addition, when the operator of the work machine 100 tilts the left operation lever 142LO in a left direction, the swing body 120 swings leftward. Incidentally, in another embodiment, when the left operation lever 142LO is tilted in a front to back direction, the swing body 120 may swing rightward or swing leftward, and when the left operation lever 142LO is tilted in a right to left direction, the arm 132 may perform an excavating operation or a dumping operation.

The right operation lever 142RO is an operation mechanism to cause the bucket 133 to perform an excavating or dumping operation and to cause the boom 131 to perform a raising or lowering operation. Specifically, when the operator of the work machine 100 tilts the right operation lever 142RO forward, a lowering operation of the boom 131 is executed. In addition, when the operator of the work machine 100 tilts the right operation lever 142RO backward, a raising operation of the boom 131 is executed. In addition, when the operator of the work machine 100 tilts the right operation lever 142RO in the right direction, a dumping operation of the bucket 133 is performed. In addition, when the operator of the work machine 100 tilts the right operation lever 142RO in the left direction, an excavating operation of the bucket 133 is performed. Incidentally, in another embodiment, when the right operation lever 142RO is tilted in the front to back direction, the bucket 133 may perform a dumping operation or an excavating operation, and when the right operation lever 142RO is tilted in the right to left direction, the boom 131 may perform a raising operation or a lowering operation.

The left foot pedal 142LF is disposed on a left side of a floor surface in front of the driver seat 141. The right foot pedal 142RF is disposed on a right side of the floor surface in front of the driver seat 141. The left traveling lever 142LT is pivotally supported by the left foot pedal 142LF and is configured such that the inclination of the left traveling lever 142LT and the pressing down of the left foot pedal 142LF are linked to each other. The right traveling lever 142RT is pivotally supported by the right foot pedal 142RF and is configured such that the inclination of the right traveling lever 142RT and the pressing down of the right foot pedal 142RF are linked to each other.

The left foot pedal 142LF and the left traveling lever 142LT correspond to rotational drive of a left crawler belt of the undercarriage 110. Specifically, when the operator of the work machine 100 tilts the left foot pedal 142LF or the left traveling lever 142LT forward, the left crawler belt rotates in a forward movement direction. In addition, when the operator of the work machine 100 tilts the left foot pedal 142LF or the left traveling lever 142LT backward, the left crawler belt rotates in a backward movement direction.

The right foot pedal 142RF and the right traveling lever 142RT correspond to rotational drive of a right crawler belt of the undercarriage 110. Specifically, when the operator of the work machine 100 tilts the right foot pedal 142RF or the right traveling lever 142RT forward, the right crawler belt rotates in the forward movement direction. In addition, when the operator of the work machine 100 tilts the right foot pedal 142RF or the right traveling lever 142RT backward, the right crawler belt rotates in the backward movement direction.

The control device 145 includes a display 145D that displays information related to a plurality of functions of the work machine 100. The control device 145 is one example of a display system. In addition, the display 145D is one example of a display unit. Input means of the control device 145 according to the first embodiment is a touch panel.

### Configuration of Control Device 145

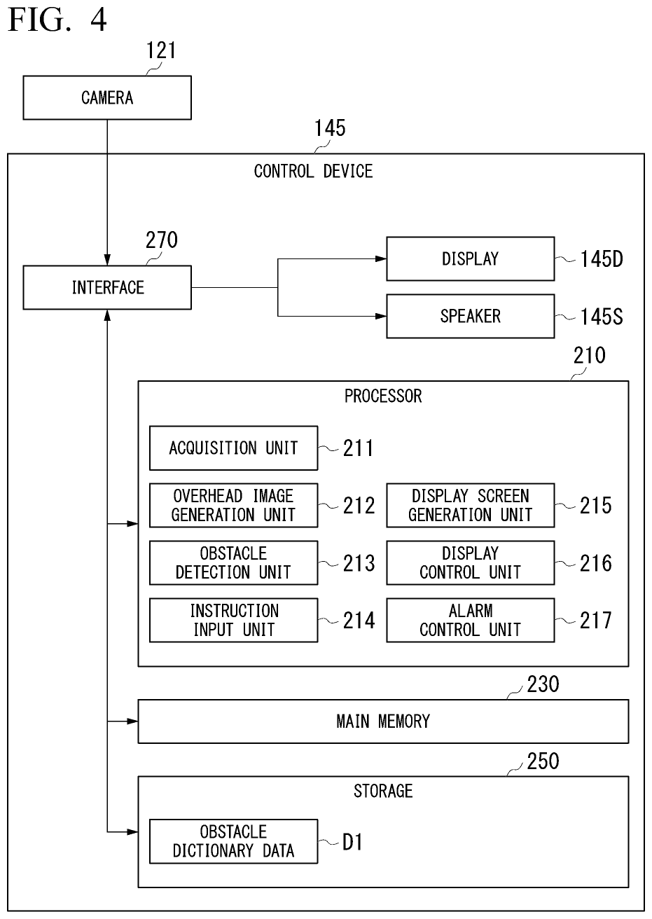

FIG. 4 is a schematic block diagram showing the configuration of the control device 145 according to the first embodiment.

The control device 145 is a computer including a processor 210, a main memory 230, a storage 250, and an interface 270. In addition, the control device 145 includes the display 145D and a speaker 145S. In addition, the control device 145 according to the first embodiment is provided integrally with the display 145D and the speaker 145S, but in another embodiment, at least one of the display 145D and the speaker 145S may be provided separately from the control device 145. Incidentally, when the display 145D and the control device 145 are separately provided, the display 145D may be provided outside the cab 140. In this case, the display 145D may be a mobile display. In addition, when the work machine 100 is driven by remote operation, the display 145D may be provided in a remote operation room provided remotely from the work machine 100. Similarly, when the speaker 145S and the control device 145 are separately provided, the speaker 145S may be provided outside the cab 140. In addition, when the work machine 100 is driven by remote operation, the speaker 145S may be provided in a remote operation room provided remotely from the work machine 100.

Incidentally, the control device 145 may be configured by a single computer, or the configuration of the control device 145 may be divided into a plurality of computers to be disposed, such that the plurality of computers may cooperate with each other to function as an obstacle reporting system for a work machine. The work machine 100 may include a plurality of computers that function as the control device 145. A portion of the computers constituting the control device 145 may be mounted inside the work machine 100, and other computers may be provided outside the work machine 100.

Incidentally, the above-mentioned one control device 145 is also one example of the obstacle reporting system for a work machine. In addition, in another embodiment, a portion of the configurations constituting the obstacle reporting system for a work machine may be mounted inside the work machine 100, and other configurations may be provided outside the work machine 100. For example, the obstacle reporting system for a work machine may be configured such that the display 145D is provided in a remote operation room provided remotely from the work machine 100. In yet another embodiment, one or a plurality of computers constituting the obstacle reporting system for a work machine may all be provided outside the work machine 100.

The camera 121, the display 145D, and speaker 145S are connected to the processor 210 via the interface 270.

Exemplary examples of the storage 250 include an optical disk, a magnetic disk, a magneto-optical disk, a semiconductor memory, or the like. The storage 250 may be an internal medium that is directly connected to a bus of the control device 145 or may be an external medium connected to the control device 145 via the interface 270 or a communication line. The storage 250 stores a program for realizing the periphery monitoring of the work machine 100. In addition, the storage 250 stores in advance a plurality of images including an icon for displaying on the display 145D.

The program may realize some of functions to be exhibited by the control device 145. For example, the program may exhibit functions in combination with another program that is already stored in the storage 250 or in combination with another program installed in another device. Incidentally, in another embodiment, the control device 145 may include a custom large scale integrated circuit (LSI) such as a programmable logic device (PLD) in addition to the above configuration or instead of the above configuration. Exemplary examples of the PLD include a programmable array logic (PAL), a generic array logic (GAL), a complex programmable logic device (CPLD), and a field programmable gate array (FPGA). In this case, some or all of the functions to be realized by the processor 210 may be realized by the integrated circuit.

In addition, the storage 250 stores an obstacle dictionary data D1 for detecting an obstacle.

The obstacle dictionary data D1 may be, for example, dictionary data of a feature amount extracted from each of a plurality of known images in which an obstacle is captured. Exemplary examples of the feature amount include histograms of oriented gradients (HOG), co-occurrence hog (CoHOG), or the like.

By executing a program, the processor 210 includes an acquisition unit 211, an overhead image generation unit 212, an obstacle detection unit 213, an instruction input unit 214, a display screen generation unit 215, a display control unit 216, and an alarm control unit 217.

The acquisition unit 211 acquires captured images from the plurality of cameras 121.

The overhead image generation unit 212 deforms and combines a plurality of the captured images acquired by the acquisition unit 211 to generate an overhead image in which the work machine 100 is centered when a site is viewed from above. Hereinafter, the captured image deformed by the overhead image generation unit 212 is also referred to as a deformed image. The overhead image generation unit 212 may cut out a portion of each of the deformed captured images and combine the cutout captured images to generate an overhead image. An image of the work machine 100 viewed from above is attached in advance to the center of the overhead image generated by the overhead image generation unit 212. That is, the overhead image is a periphery image in which the periphery of the work machine 100 is captured.

The obstacle detection unit 213 detects an obstacle from each captured image acquired by the acquisition unit 211. That is, the obstacle detection unit 213 is one example of an obstacle determination unit that determines whether an obstacle exists in the periphery of the work machine 100. Exemplary examples of an obstacle include a person, a vehicle, a rock, or the like. In addition, when an obstacle is detected, the obstacle detection unit 213 specifies a region in which the obstacle exists among the left rear region Ra, the rear region Rb, the right rear region Rc, and the right front region Rd.

The obstacle detection unit 213 detects an obstacle by, for example, the following procedure. The obstacle detection unit 213 extracts the feature amount from each captured image acquired by the acquisition unit 211. The obstacle detection unit 213 detects an obstacle from the captured image based on the extracted feature amount and the obstacle dictionary data. Exemplary examples of an obstacle detection method include pattern matching, object detection processing based on machine learning, or the like.

Incidentally, in the first embodiment, the obstacle detection unit 213 detects a person by using the feature amount of the image but is not limited thereto. For example, in another embodiment, the obstacle detection unit 213 may detect an obstacle based on a measured value of light detection and ranging (LiDAR), or the like.

The instruction input unit 214 receives a touch operation input of the operator to the touch panel of the control device 145. In particular, the instruction input unit 214 receives a pinch-out operation on the touch panel as an enlargement instruction for displaying an obstacle on the display 145D. The pinch-out operation refers to an operation in which two fingers touching the touch panel are separated from each other. The instruction input unit 214 specifies the coordinates of the two fingers according to the pinch-out operation on the touch panel.

The display screen generation unit 215 generates a display screen data G1 in which a marker G12 indicating the position of an obstacle is disposed at the position corresponding to the detection position of the obstacle by being superimposed on an overhead image G11 generated by the overhead image generation unit 212. The disposition of the marker G12 on the display screen data G1 is one example of the reporting of the existence of the obstacle. When the instruction input unit 214 receives the enlargement instruction, the display screen generation unit 215 enlarges the display of the obstacle indicated by the enlargement instruction in the overhead image G11. Enlarging the display of the obstacle is one example of changing the display mode of the obstacle. The display screen generation unit 215 restores the display of the overhead image G11 after a certain period of time since the enlargement instruction is received.

An example of the display screen will be described later.

The display control unit 216 outputs the display screen data G1 generated by the display screen generation unit 215 to the display 145D. As a result, the display 145D displays the display screen data G1. The display control unit 216 is one example of a reporting unit.

The alarm control unit 217 outputs an alarm sound signal to the speaker 145S when the obstacle detection unit 213 detects an obstacle. The alarm control unit 217 is one example of a reporting unit.

### About Display Screen

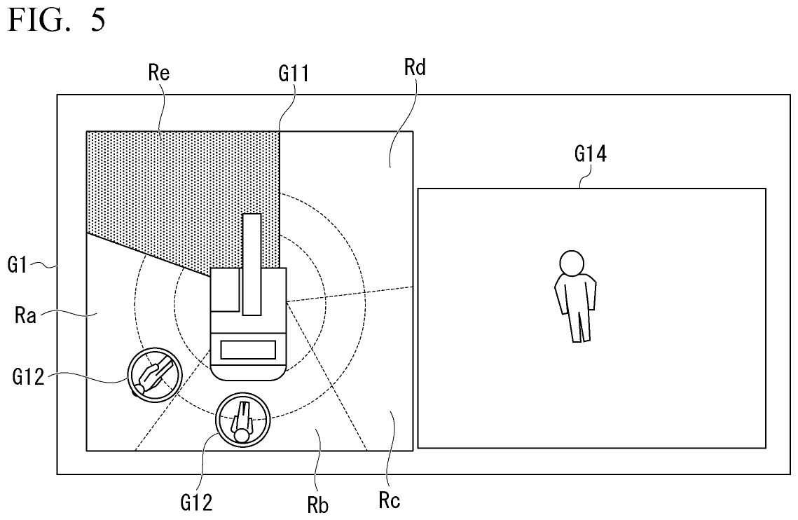

FIG. 5 is a diagram showing an example of a display screen according to the first embodiment.

As shown in FIG. 5, the display screen data G1 includes the overhead image G11, the marker G12, and a single camera image G14.

The overhead image G11 is an image of the site viewed from above. The overhead image G11 has the left rear region Ra in which a deformed image according to the left rear camera 121A is shown, the rear region Rb in which a deformed image according to the rear camera 121B is shown, the right rear region Rc in which a deformed image according to the right rear camera 121C is shown, the right front region Rd in which a deformed image according to the right front camera 121D is shown, and the left front region Re in which an image is not shown. Incidentally, the boundary lines of the regions of the left rear region Ra, the rear region Rb, the right rear region Rc, the right front region Rd, and the left front region Re are not displayed in the overhead image G11.

The marker G12 indicates the position of an obstacle. The shape of the marker G12 includes, for example, a circle, an ellipse, a regular polygon, and a polygon.

The single camera image G14 is a single camera image captured by one camera 121.

### Reporting Method of Obstacle

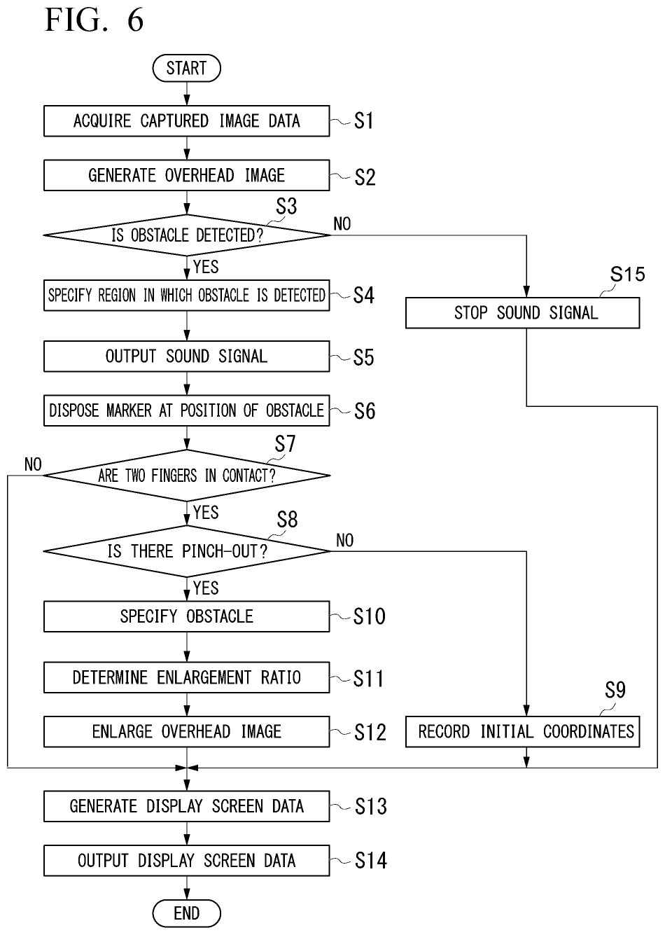

FIG. 6 is a flowchart showing an operation of the control device 145 according to the first embodiment.

When the control device 145 starts periphery monitoring processing, the acquisition unit 211 acquires captured images from the plurality of cameras 121 (step S1).

Next, the overhead image generation unit 212 deforms and combines a plurality of the captured images acquired in the step S1 to generate the overhead image G11 in which the work machine 100 is centered when a site is viewed from above (step S2). At this time, the overhead image generation unit 212 records each deformed image before combination in the main memory 230. Next, the obstacle detection unit 213 executes an obstacle detection processing for each captured image acquired in the step S1 and determines whether an obstacle is detected (step S3).

When an obstacle is detected in the captured image (step S3: YES), the obstacle detection unit 213 specifies a region in which an obstacle is detected among the left rear region Ra, the rear region Rb, the right rear region Rc, and the right front region Rd (step S4). That is, when an obstacle is detected in the captured image of the left rear camera 121A, the obstacle detection unit 213 determines that the region in which the obstacle is detected is the left rear region Ra. When an obstacle is detected in the captured image of the rear camera 121B, the obstacle detection unit 213 determines that the region in which the obstacle is detected is the rear region Rb. When an obstacle is detected in the captured image of the right rear camera 121C, the obstacle detection unit 213 determines that the region in which the obstacle is detected is the right rear region Rc. When an obstacle is detected in the captured image of the right front camera 121D, the obstacle detection unit 213 determines that the region in which the obstacle is detected is the right front region Rd.

The alarm control unit 217 outputs an alarm sound signal to the speaker 145S (step S5). In addition, the display screen generation unit 215 disposes the marker G12 at a position corresponding to the detected obstacle in the overhead image G11 generated in the step S2 (step S6).

The instruction input unit 214 determines whether two fingers are in contact with the touch panel (step S7). When two fingers are in contact with the touch panel (step S7: YES), the instruction input unit 214 determines whether an enlargement instruction by a pinch-out operation is received from the operator (step S8). For example, the instruction input unit 214 determines that a pinch-out operation is performed when two fingers are in contact with the touch panel and the distance between the two fingers is greater than or equal to the distance at the start of contact by a predetermined threshold value.

When the pinch-out operation is not performed (step S8: NO), the instruction input unit 214 specifies the coordinates of the two fingers on the touch panel and records the coordinates in the main memory 230 as initial coordinates (step S9). The initial coordinates recorded in the step S9 can be regarded as the coordinates at the start of the pinch-out operation when the pinch-out operation is performed by the two fingers detected this time.

When a pinch-out operation is performed (step S8: YES), the instruction input unit 214 specifies the obstacle designated by the operator based on the initial coordinates of the two fingers stored in the main memory 230 (step S10). Specifically, the instruction input unit 214 specifies the obstacle having the shortest distance from the central coordinates of the initial coordinates of the two fingers among the obstacles detected in the step S3 as the obstacle designated by the operator. In addition, the instruction input unit 214 determines the enlargement ratio based on the initial coordinates of the two fingers and the current coordinates of the two fingers (step S11). For example, the instruction input unit 214 determines the enlargement ratio by multiplying the ratio of the distance between the two fingers according to the initial coordinates and the current distance between the two fingers by a predetermined coefficient.

The overhead image generation unit 212 enlarges, in the overhead image generated in the step S2, the portion of the region in which the obstacle specified in the step S10 exists according to the enlargement ratio determined in the step S11 (step S12). At this time, the overhead image generation unit 212 enlarges the image centering on the obstacle specified in the step S10.

The display screen generation unit 215 generates the display screen data G1 in which the overhead image G11 enlarged in the step S12, the marker G12 disposed in the step S6, and the single camera image G14 acquired in the step S1 are disposed (step S13). The display control unit 216 outputs the generated display screen data G1 to the display 145D (step S14). That is, when an enlargement instruction is input, the display control unit 216 outputs an enlarged image centering on the detected obstacle.

On the other hand, when the two fingers are not in contact with the touch panel in the step S7 (step S7: NO), or when the initial coordinates of the two fingers are recorded in the step S9 (step S9), the display screen generation unit 215 generates the display screen data G1 in which the overhead image G11 generated in the step S2, the marker G12 disposed in the step S6, and the single camera image G14 acquired in the step S1 are disposed (step S13). The display control unit 216 outputs the generated display screen data G1 to the display 145D (step S14). In other words, when no enlargement instruction is input, the display control unit 216 outputs the overhead image G1 in which the obstacle is not enlarged.

When an obstacle is not detected in the captured image in the step S3 (step S3: YES), the alarm control unit 217 stops the output of the sound signal (step S11). The display screen generation unit 215 generates display screen data G1 in which the overhead image G11 generated in the step S2 and the single camera image G14 acquired in the step S1 are disposed (step S13). The display control unit 216 outputs the generated display screen data G1 to the display 145D (step S14).

By repeatedly executing the above-described processing, the control device 145 attaches the marker G12 to the detected obstacle superimposed on the overhead image G11 and can enlarge and display a portion of the overhead image centering on the obstacle when the enlargement instruction is given by a pinch-out operation.

Incidentally, the flowchart shown in FIG. 6 is one example, and in another embodiment, all the steps may not be necessarily executed. For example, in another embodiment, when the reporting by the alarm is not performed, the processing of the step S5 and the step S11 may not be executed. In addition, for example, in another embodiment, when the reporting by the marker G12 is not performed, the processing of the step S6 may not be executed. In addition, in another embodiment, when the enlargement instruction is given by a tap operation, a double-tap operation, a long-press operation, or the like, instead of a pinch-out operation, the specification of the initial coordinates in the step S9 and the determination of the enlargement ratio in the step S11 may not have to be performed. When an enlargement instruction is given by a tap operation, a double-tap operation, or the like, the enlargement ratio is fixed. In addition, the touch operation may be performed using a touch pen or the like instead of a finger F.

### Operation Example

Hereinafter, an operation example of the control device 145 according to the first embodiment will be described with reference to the drawings.

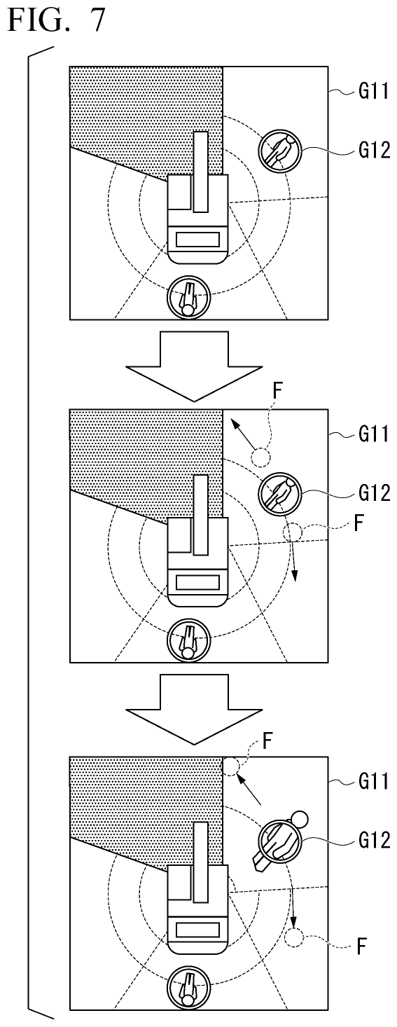

FIG. 7 is a diagram showing an operation example of the control device 145 according to the first embodiment.

When the obstacle detection unit 213 of the control device 145 detects an obstacle in the periphery of the work machine 100 in the step S3, the obstacle detection unit 213 specifies the region detected in the step S4. Here, for example, when an obstacle is detected in the captured image of the right front camera 121D and the captured image of the rear camera 121B, the obstacle detection unit 213 specifies that the regions in which the obstacle is detected are the rear region Rb and the right front region Rd.

By listening to the alarm issued from the speaker 145S and visually recognizing the display 145D, the operator recognizes that an obstacle exists in the rear region Rb and the right front region Rd. Here, when it is difficult for the operator to recognize the obstacle in the right front region Rd, the operator issues an enlargement instruction to confirm the obstacle. That is, as shown in FIG. 7, the operator brings the two fingers F into contact with the vicinity of the obstacle to be enlarged and performs the operation of separating the two fingers.

At this time, the instruction input unit 214 of the control device 145 first records the initial coordinates in the step S9 at the start of pinch-out and specifies the obstacle closest to the two fingers F in the step S10 during the pinch-out operation. Here, the instruction input unit 214 specifies an obstacle in right front region Rd. The instruction input unit 214 determines the enlargement ratio in the step S11 and enlarges the deformed image of the right front region Rd centering on the specified obstacle at the enlargement ratio determined in the step S11.

### Operation and Effects

The control device 145 according to the first embodiment performs reporting indicating an obstacle when determination is made that an obstacle exists in the periphery of the work machine and changes the display mode of the obstacle when an operation instruction in response to the reporting is received. As a result, the operator can easily acquire information about the detected obstacle by performing a predetermined operation instruction to confirm the obstacle.

In addition, the control device 145 according to the first embodiment enlarges the deformed image centering on the target obstacle by the pinch-out operation. As a result, the operator can acquire an enlarged image of the obstacle through intuitive operations. In addition, by performing enlargement centering on the obstacle instead of the initial coordinates of the pinch-out operation, the obstacle can be prevented from appearing outside the screen due to the enlargement.

### Modification Example

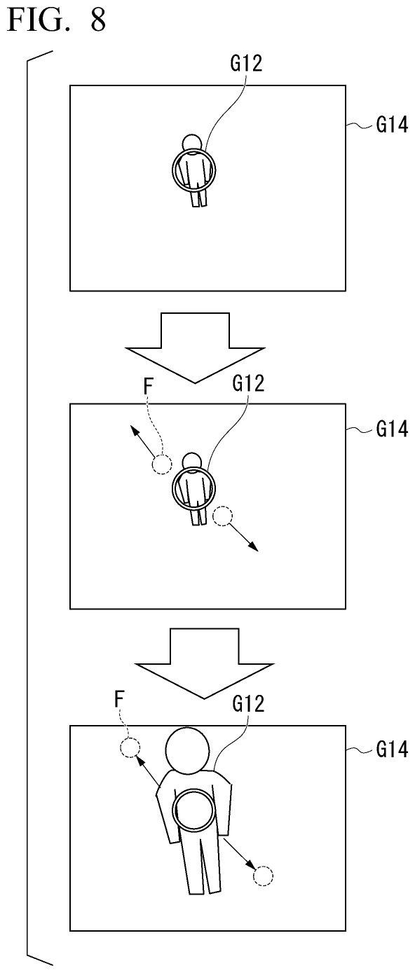

Incidentally, the control device 145 according to the first embodiment enlarges a portion of the overhead image G11 by the enlargement instruction for the overhead image G11, but the present invention is not limited thereto. FIG. 8 is a diagram showing an operation example of the control device 145 according to the modification example of the first embodiment.

For example, the control device 145 according to a first modification example may attach the marker G12 to the single camera image G14 as shown in FIG. 8. In this case, the control device 145 may enlarge the single camera image G14 centering on the obstacle based on the enlargement instruction.

### Second Embodiment

The control device 145 according to the first embodiment receives an enlargement instruction by a pinch-out operation and enlarges a partial region of the overhead image G11. On the other hand, the control device 145 according to the second embodiment receives an enlargement instruction by a tap operation and displays an enlarged image of the obstacle separately from the overhead image G11. Displaying an enlarged image of the obstacle separately from the overhead image G11 is one example of changing the display mode of the obstacle.

The configuration of the control device 145 according to the second embodiment is the same as the configuration of the first embodiment. A control device 145 according to the second embodiment differs from the first embodiment in the operation of the instruction input unit 214 and the display screen generation unit 215.

The instruction input unit 214 according to the second embodiment receives a double-tap operation on the touch panel as an enlargement instruction for displaying an obstacle on the display 145D. A double-tap operation is an operation of touching the touch panel twice at short time intervals. The instruction input unit 214 specifies the coordinates of the finger according to the double-tap operation on the touch panel.

When the instruction input unit 214 receives an enlargement instruction, the display screen generation unit 215 enlarges the display of the obstacle in the captured image and generates the display screen data G1 in which the enlarged image G15 obtained by performing cropping centering on the obstacle is disposed. The enlarged image G15 is generated from the captured image instead of the deformed image. The enlarged image G15 is disposed in the left front region Re of the overhead image G11 in which no image is shown. Displaying the enlarged image of the obstacle in a portion in which the image is not shown is one example of changing the display mode of the obstacle.

### Reporting Method of Obstacle

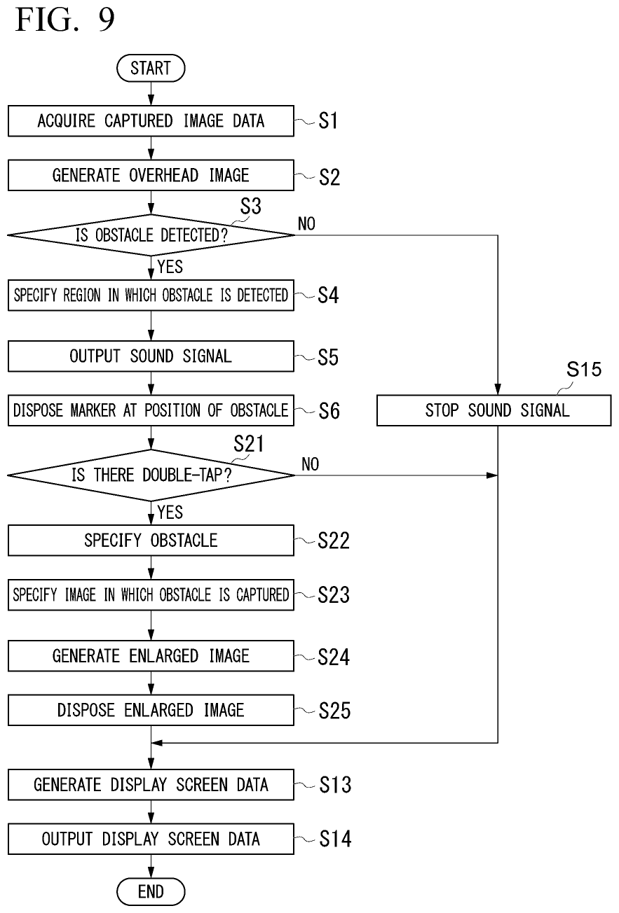

FIG. 9 is a flowchart showing an operation of the control device 145 according to the second embodiment.

The control device 145 according to the second embodiment executes the steps S22 to S25 shown below instead of the steps S7 to S12 according to the first embodiment.

When the display screen generation unit 215 disposes the marker G12 in the step S6, the instruction input unit 214 determines whether a double-tap operation is performed on the touch panel (step S21). When the double-tap operation is not performed (step S21: NO), the display screen generation unit 215 generates the display screen data G1 in which the overhead image G11 generated in the step S2, the marker G12 disposed in the step S6, and the single camera image G14 acquired in the step Si are disposed (step S13). The display control unit 216 outputs the generated display screen data G1 to the display 145D (step S14). In other words, the display control unit 216 outputs the display screen data G1 that does not include the enlarged image G15 when no enlargement instruction is input.

On the other hand, when the double-tap operation is performed (step S21: YES), the instruction input unit 214 specifies the obstacle designated by the operator based on the coordinates according to the double-tap operation (step S22). Specifically, the instruction input unit 214 specifies the obstacle having the shortest distance from the coordinates touched last among the obstacles detected in the step S3 as the obstacle designated by the operator. The display screen generation unit 215 specifies, among the captured images acquired in the step S1, a captured image in which the obstacle specified in the step S22 is captured (step S23). The display screen generation unit 215 generates an enlarged image by enlarging the captured image at a predetermined enlargement ratio and cropping the captured image to a predetermined size, centering on the obstacle specified in the step S22 (step S24). For example, the predetermined enlargement ratio may be a predetermined fixed enlargement ratio, and a fixed enlarged image may be generated. The display screen generation unit 215 disposes the generated enlarged image in the left front region Re of the overhead image G11 (step S25). At this time, the display screen generation unit 215 may connect the enlarged image and the obstacle specified in the step S22 with a line to indicate which obstacle the enlarged image indicates.

The display screen generation unit 215 generates the display screen data G1 in which the overhead image G11 enlarged in the step S12, the marker G12 disposed in the step S6, the single camera image G14 acquired in the step S1, and the enlarged image G15 are disposed (step S13). The display control unit 216 outputs the generated display screen data G1 to the display 145D (step S14). That is, when an enlargement instruction is input, the display control unit 216 outputs an enlarged image centering on the detected obstacle. The display screen generation unit 215 may delete the enlarged image G15 from the display screen data G1 when a certain period of time is passed since the start of displaying the enlarged image G15.

### Operation Example

Hereinafter, an operation example of the control device 145 according to the second embodiment will be described with reference to the drawings.

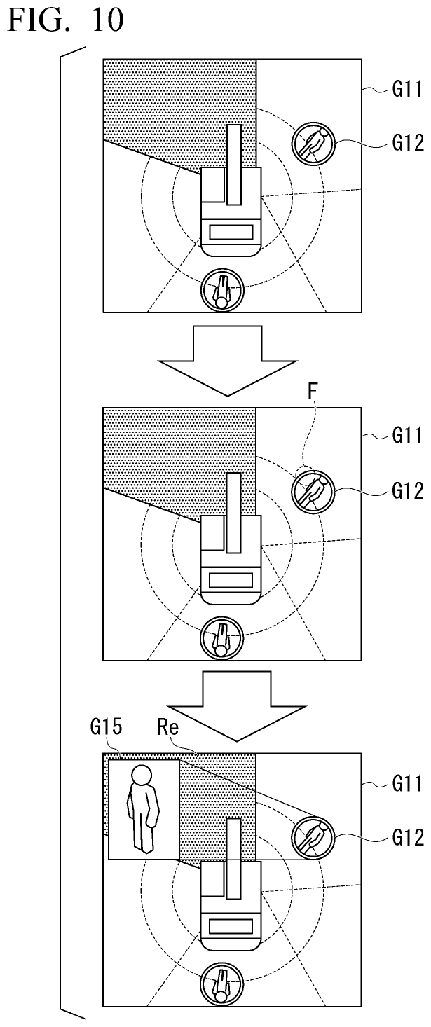

FIG. 10 is a diagram showing an operation example of the control device 145 according to the second embodiment.

When the obstacle detection unit 213 of the control device 145 detects an obstacle in the periphery of the work machine 100 in the step S3, the obstacle detection unit 213 specifies the region detected in the step S4. Here, for example, when an obstacle is detected in the captured image of the right front camera 121D and the captured image of the rear camera 121B, the obstacle detection unit 213 specifies that the regions in which the obstacle is detected are the rear region Rb and the right front region Rd.

By listening to the alarm issued from the speaker 145S and visually recognizing the display 145D, the operator recognizes that an obstacle exists in the rear region Rb and the right front region Rd. Here, when it is difficult for the operator to recognize the obstacle in the right front region Rd, the operator issues an enlargement instruction to confirm the obstacle. That is, the operator performs a double-tap operation in the vicinity of the obstacle to be enlarged, as shown in FIG. 10.

At this time, the instruction input unit 214 specifies the obstacle closest to the coordinates of the last contact. Here, the instruction input unit 214 specifies an obstacle in right front region Rd. In the step S24, the display screen generation unit 215 generates the enlarged image G15 by enlarging and cropping the captured image, in which the specified obstacle is shown, centering on the specified obstacle. In the step S25, the display screen generation unit 215 disposes the enlarged image G15 in the left front region Re of the overhead image G11.

### Effects

The control device 145 according to the second embodiment generates the enlarged image G15 by enlarging not the deformed image but the captured image centering on the target obstacle. Since the deformed image generated for the overhead image G11 is obtained by distorting the original captured image, there is a possibility that the obstacle shown in the deformed image is also distorted. Therefore, the control device 145 presents the enlarged image G15 obtained by enlarging the captured image instead of the deformed image, and thus can provide the operator with an image in which the obstacle is visually recognized easily.

### Modification Example

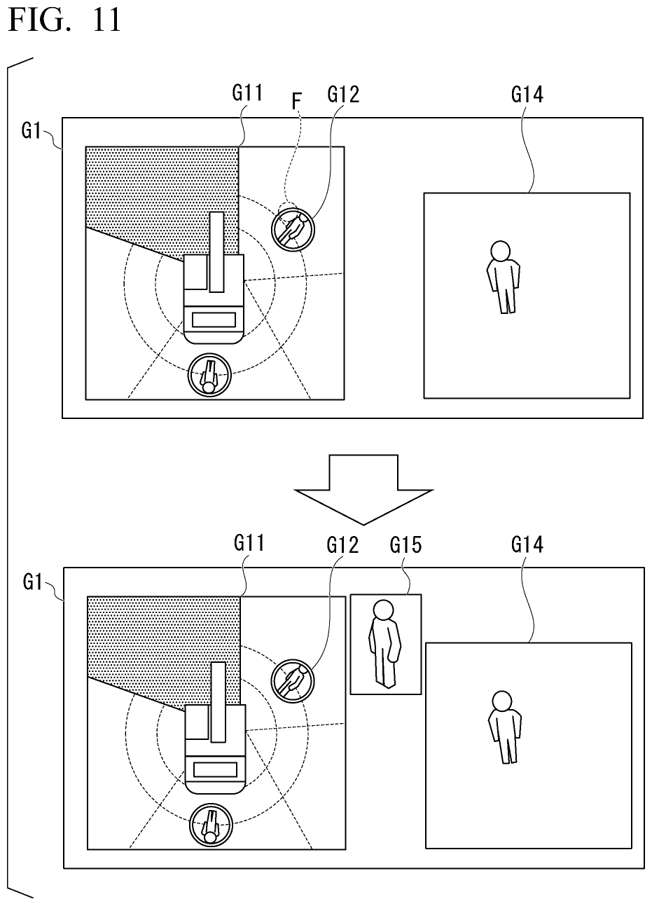

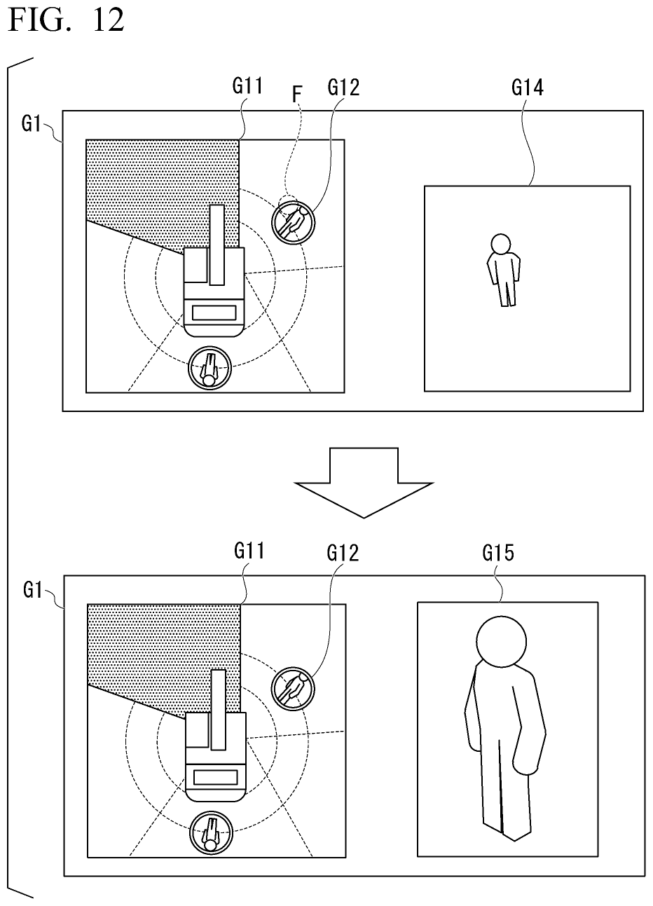

Incidentally, although the control device 145 according to the second embodiment disposes the enlarged image G15 in the left front region Re of the overhead image G11, the present invention is not limited thereto. FIG. 11 is a diagram showing an operation example of the control device 145 according to a first modification example of the second embodiment. FIG. 12 is a diagram showing an operation example of the control device 145 according to a second modification example of the second embodiment.

For example, the control device 145 according to the first modification example may dispose the enlarged image G15 between the overhead image G11 and the single camera image G14, as shown in FIG. 11. Further, for example, the control device 145 according to the second modification example may dispose the enlarged image G15 instead of the single camera image G14, as shown in FIG. 12.

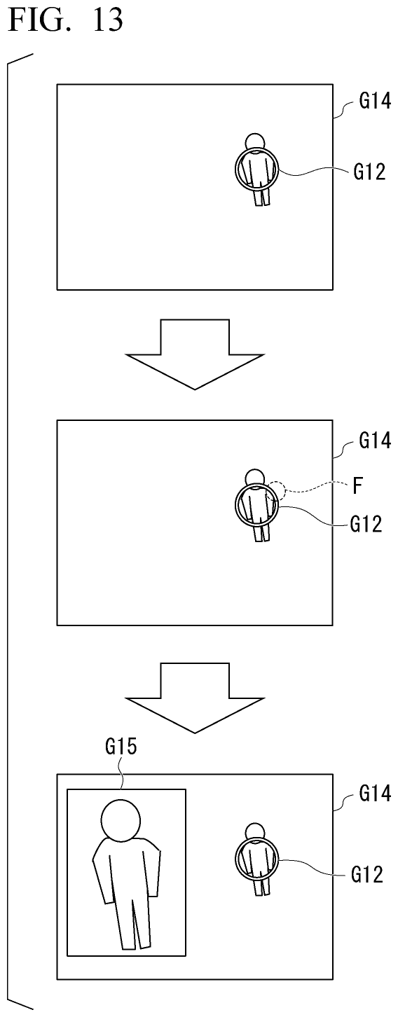

The control device 145 according to the second embodiment generates the enlarged image G15 by the enlargement instruction with respect to the overhead image G11 but is not limited thereto. FIG. 13 is a diagram showing an operation example of the control device 145 according to a third modification example of the second embodiment.

For example, the control device 145 according to the third modification example may attach the marker G12 to the single camera image G14 as shown in FIG. 13. In this case, the control device 145 may generate the enlarged image G15 based on the enlargement instruction on the single camera image G14 and may dispose the enlarged image G15 on the single camera image G14.

### Third Embodiment

The control device 145 according to the first and second embodiments enlarges an obstacle in an image based on an enlargement instruction. On the other hand, the control device 145 according to the third embodiment receives a type display instruction by a tap operation and displays the type of the obstacle in the vicinity of the obstacle. Displaying the type of the obstacle in the vicinity of the obstacle is one example of changing the display mode of the obstacle.

The configuration of the control device 145 according to the third embodiment is the same as the configuration of the second embodiment. The control device 145 according to the third embodiment differs from the second embodiment in the operations of the obstacle detection unit 213, the instruction input unit 214, and the display screen generation unit 215.

The obstacle detection unit 213 according to the third embodiment specifies the type of the obstacle when the obstacle is detected. For example, when an obstacle is detected by pattern matching, the obstacle detection unit 213 prepares a pattern for each type of obstacle in advance, and specifies the type associated with the matched pattern as the type of the obstacle. For example, when the obstacle detection unit 213 detects an obstacle by object detection processing based on machine learning, the model is trained in advance to output a label indicating the type of the obstacle, and the type of the obstacle is specified based on the label.

The instruction input unit 214 according to the third embodiment receives a double-tap operation on the touch panel as a type display instruction for displaying an obstacle on the display 145D.

When the instruction input unit 214 receives the type display instruction, the display screen generation unit 215 disposes the type display of the obstacle in the vicinity of the obstacle in the captured image.

### Operation Example

Hereinafter, an operation example of the control device 145 according to the third embodiment will be described with reference to the drawings.

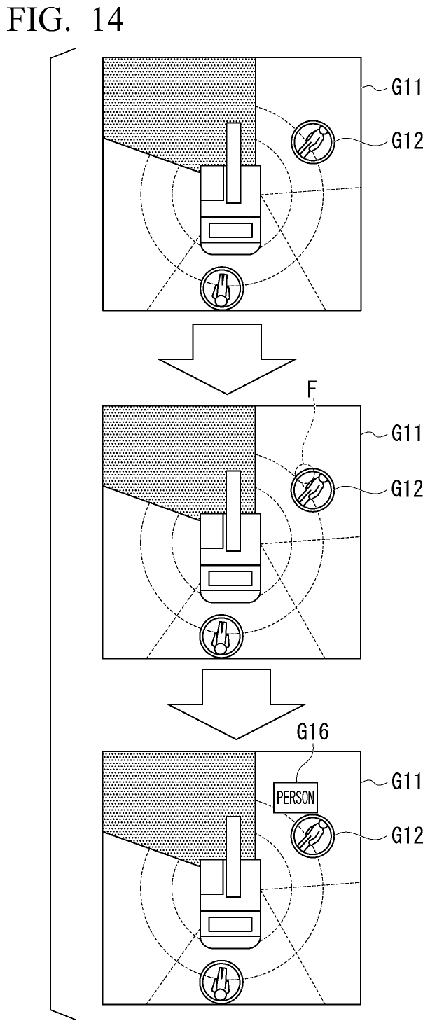

FIG. 14 is a diagram showing an operation example of the control device 145 according to the third embodiment.

When the obstacle detection unit 213 of the control device 145 detects an obstacle in the periphery of the work machine 100, the obstacle detection unit 213 specifies the type of the obstacle and the region in which the obstacle is detected. By listening to the alarm issued from the speaker 145S and visually recognizing the display 145D, the operator recognizes that the obstacle exists. Here, when it is difficult for the operator to recognize the obstacle in the right front region Rd, the operator issues a type display instruction to confirm the obstacle. The instruction input unit 214 specifies the obstacle closest to the coordinates of the last contact. The display screen generation unit 215 generates a label image G16 that displays the type of the specified obstacle. The display screen generation unit 215 disposes the label image G16 at the coordinates according to the type display instruction.

### Operation and Effects

The control device 145 according to the third embodiment generates the label image G16 representing the type of the target obstacle. The control device 145 can allow the operator to recognize the type of the obstacle by presenting the label image G16.

### Modification Example

Incidentally, although the control device 145 according to the third embodiment displays the type of the obstacle on the display 145D, the present invention is not limited thereto. For example, the control device 145 according to another embodiment may cause the speaker 145S to output a sound representing the type of the obstacle instead of the display on the display 145D.

### Another Embodiment

The embodiments have been described above in detail with reference to the drawings; however, the specific configurations are not limited to the above-described configurations, and various design changes or the like can be made. That is, in another embodiment, the order of the above-described processing may be appropriately changed. In addition, some of the processing may be executed in parallel.

The control device 145 according to the above-described embodiment performs the reporting of the obstacle by the display of the marker G12 on the display 145D, the display of the alarm icon G13, and the alarm from the speaker 145S but is not limited thereto in another embodiment. For example, the control device 145 according to another embodiment may perform the reporting of the obstacle by the intervention control of the work machine 100.

In addition, the work machine 100 according to the above-described embodiment is a hydraulic excavator but is not limited thereto. For example, the work machine 100 according to another embodiment may be another work machine such as a dump truck, a bulldozer, or a wheel loader.

In addition, in the example of the display screen shown in FIG. 5 or the like, it is assumed that the display screen does not display the boundary lines of the regions of the left rear region Ra, the rear region Rb, the right rear region Rc, the right front region Rd, and the left front region Re; but is not limited thereto. Another embodiment may display the boundary lines of the regions on the display screen.

The obstacle detection unit 213 of the control device 145 according to the above-described embodiment specifies a region in which an obstacle exists but is not limited thereto. For example, the control device 145 according to another embodiment may not specify a region in which the obstacle exists. In this case, the control device 145 may specify an obstacle closest to the contact coordinates based on the enlargement instruction or the type display instruction, and may perform enlargement centering on the obstacle or may display the type of the obstacle in the vicinity of the obstacle.

Although the control device 145 according to the above-described embodiment specifies the obstacle closest to the contact coordinates by the enlargement instruction or the type display instruction, the present invention is not limited thereto. For example, centering on the obstacle existing in a region for which the enlargement instruction is given, the control device 145 may enlarge the deformed image related to the region. Alternatively, the control device 145 may display the enlarged image in the left front region Re in which no image is captured, between the overhead image G11 and the single camera image G14, or the like. Incidentally, the control device 145 may change the mode of enlargement display according to the number of obstacles existing in the region for which the enlargement instruction is given. For example, when the number of obstacles existing in the region for which the enlargement instruction is given is one, the control device 145 enlarges the deformed image related to the region centering on the obstacle, and when the number of obstacles for which the enlargement instruction is given is two or more, displays an image in which each obstacle is enlarged in the left front region Re in which no image is shown, between the overhead image G11 and the single camera image G14, or the like. In addition, for example, the control device 145 may display the type of the obstacle in the vicinity of the obstacle existing in the region for which the type display instruction is given.

### Reference Signs List

100: Work machine
110: Undercarriage
120: Swing body
121: Camera
130: Work equipment
145: Control device
145D: Display
145S: Speaker
211: Acquisition unit
212: Overhead image generation unit
213: Obstacle detection unit
214: Instruction input unit
215: Display screen generation unit
216: Display control unit
217: Alarm control unit

1. An obstacle reporting system for a work machine comprising:
an obstacle determination unit configured to determine whether an obstacle exists in a periphery of a work machine;
a reporting unit configured to perform reporting showing the obstacle when determination is made that the obstacle exists;
an instruction input unit configured to receive an operation instruction for the reporting; and
an output unit configured to change a display mode of the obstacle based on the operation instruction.

2. The obstacle reporting system according to claim 1,
wherein a change of the display mode is enlargement of a display of the obstacle.

3. The obstacle reporting system according to claim 2,
wherein the enlargement of the display of the obstacle is outputting an enlarged image of the obstacle based on a fixed enlargement ratio.

4. The obstacle reporting system according to claim 2,
wherein the enlargement of the display of the obstacle is outputting an enlarged image of the obstacle based on an enlargement ratio determined based on the operation instruction.

5. The obstacle reporting system according to claim 2,
wherein the reporting unit includes a touch panel, and
the operation instruction is a pinch-out operation on the touch panel on which the obstacle is displayed.

6. The obstacle reporting system according to claim 1, further comprising:
an obstacle detection unit configured to specify a type of the obstacle according to the reporting,
wherein the output unit outputs the type of the obstacle according to the reporting based on the operation instruction.

7. An obstacle reporting method for a work machine comprising the steps of:
determining whether an obstacle exists in a periphery of a work machine;
performing reporting showing the obstacle when determination is made that the obstacle exists;
receiving an operation instruction for the reporting; and
changing a display mode of the obstacle based on the operation instruction.
